(19) United States
(12) Patent Application Publication
(10) Pub. No.: US 2011/0055582 A1
(43) Pub. Date: Mar. 3, 2011

(54) HASH FUNCTION USING A DOMINO GAME PROCESS

(75) Inventors: Benoit CHEVALLIER-MAMES, Paris (FR); Mathieu Ciet, Paris (FR); Augustin J. Farrugia, Cupertino, CA (US)

(73) Assignee: Apple Inc., Cupertino, CA (US)

(21) Appl. No.: 12/551,362

(22) Filed: Aug. 31, 2009

(51) Int. Cl. H04L 9/28; G06F 21/00; G06F 7/04; H04L 9/32

(52) U.S. Cl. 713/181; 713/193

(57) ABSTRACT

In the computer data security field, cryptographic hash function processes are embodied in a computer system and may be keyless, but are highly secure. The processes are based on the type of randomness exhibited by the well known game of dominos using a set of tiles arranged by players on a surface. Computation of the hash value (digest) is the result of executing in computer code or logic circuitry an algorithm which models such a domino game using the message as an input to the domino game algorithm, then executing the domino game algorithm. A state of the game algorithm which models the final layout of the pieces (tiles) gives the hash digest value of the message.

### FIELD OF THE INVENTION

This invention relates to computers, computer data security, and hash functions (hashing).

### BACKGROUND

Hash functions are well known in the field of data security. The principle is to take data (a digital message, digital signature, etc.) and use it as an entry to a hash function resulting in an output called a “digest” of predetermined length which is intended to uniquely identify (“fingerprint”) the message. A secure (cryptographic) hash is such that any alteration in the message results in a different digest, even though the digest is much shorter than the message. Such hash functions are “collision-resistant” and “one-way.”

Cryptography and data security deal with digital signatures, encryption, document authentication, and hashing. In all of these fields, there is a set of basic tools/functions which are widely used, for instance hash functions. Several properties are required for the use of hash functions in cryptographic applications: preimage resistance, second preimage resistance and collision resistance.

In the recent years, much energy has been expended finding new hash functions, since collisions (weaknesses or successful attacks) have been found in the widely used SHA-1 standard hash.

### SUMMARY

Disclosed here is a new type of cryptographic (secure) hash function or process. The goal is a highly modular hash function that is also computationally efficient (fast). The present hash function can conventionally be used for document integrity for exchanges and signatures. It can be also used as a derivation function or as a HMAC (hash message authentication code) by adding a key conventionally (as in for instance the well known HMAC-SHA1) and the term “hash” as used herein is intended to encompass all these uses, both keyed and non-keyed.

A hash function is a deterministic procedure that accepts an arbitrary input value, and returns a hash value of a given size. The input value is called the message, and the resulting output hash value is called the digest. The message is authenticated by comparing the computed digest to an expected digest associated with the message.

The present hash function process is based on the concept and rules of physical domino games. Dominos or “dominoes” generally refers to the game pieces (tiles) and to the games played with such pieces. Each piece is a rectangular object having two ends, each end having zero to N (N usually is 6) spots. Many games can be played with these pieces. Generally the games involve blocking where the goal is to empty a player's hand of pieces while blocking opponents by laying the pieces to form a line of play on a surface. Generally one can only lay an end of a piece next to an end of a piece on the line of the play having the same number of spots. The set of pieces is referred to as a deck or packet or pack.

In a hash function, the entry (input) is a message. Here, in one embodiment the message is used only once as the seed for a conventional PRNG (pseudo random number generator), and then the process of the domino game is applied. No actual (physical) domino game is played or even displayed in accordance with the invention and there are no actual players. Instead a “notional” domino game (in terms only of placement of the pieces) is modeled mathematically, without players or physical pieces (tiles). In accordance with the present hash function, there is no introduction of randomness from a user since the way the pieces are placed is uniquely determined by the input which is the message to be hashed or the result/output of the PRNG (several calls) in one embodiment. This means the hash function disclosed here is completely deterministic. The notional domino game is any one of the above described games or variants thereof; it does not need to conform to any such actual game in terms of rules (such as the configuration of the tiles) or the layout of the tiles.

The present approach is based on the observation that actual domino games exhibit a high degree of chaos in the way the dominoes are arranged in the line of play. The present goal is to use the principles of such games to compute a hash function since such a chaotic (randomness) characteristic is a key feature to provide a secure hash function. In this sense secure means strongly one way, meaning that given a message it is easy to compute the digest, but it is very difficult to find a message that returns a given digest.

Since domino games are well known and exist in many variants, programming details of the present game modeling algorithm (which models such games as a process in accordance with the invention) are given here in one exemplary embodiment. Writing computer code (or designing equivalent logic circuitry) for variants would be routine to one skilled in the art in light of this disclosure. Moreover the present hash function is computed very rapidly in computer software (or hardware—dedicated logic circuitry). For instance, a hash “checksum” as used when transferring data requires fast determination of the digest. This hash function is especially useful when transferring large amounts of data.

Note that terms such as “domino,” “piece,” “tile,” “packet,” “deck,” “board,” “hand,” “player” and “game” used here in connection with the present invention do not refer to any physical object or game or person or any actual depiction of same even on a computer or game display, but are notional and refer instead to values, identifiers, or variables used in computer code or logic to compute a hash function or equivalent, and are used only for convenience of understanding herein as referring conceptually to analogous aspects of the above described domino games.

### BRIEF DESCRIPTION OF THE FIGURES

FIG. 1 shows a set of variables and parameters.

FIG. 2 shows relevant portions of a computing device for carrying out the present method.

FIG. 3 shows additional detail of the FIG. 2 computing device.

### DETAILED DESCRIPTION

The present hash function is based on the well-known set of games generally referred to as dominos. The present domino game algorithm is as follows and expressed logically in pseudo code depicted below. There is provided a large capacity buffer (memory) called RngBuffer that is initialized with the message. This buffer is then mixed, using techniques used in pseudo random number generation expressed as function InitPRNG (in order to avoid known cryptanalytic attacks). Given a message, in one embodiment, the message is conventionally initially padded to avoid certain cryptanalytic attacks. The process is thereby deterministic and no actual randomness is introduced.

During execution of the algorithm, buffer RngBuffer is either used to obtain pseudo-randomly generated integers (with a call to the function GetRNG where RNG stands for random number generator), or the content of buffer RNGBuffer is modified by calls to function InsertPRNG, which is a function where the user inserts a value of his choice (the last argument of the function), to provide diversification (greater randomness). In other words, when function InsertPRNG is invoked (called), the buffer RNGBuffer is “refreshed” (updated) using the value given by the caller. Thus, calling function InsertPRNG with one value or one other results in a different state of buffer RNGBuffer at the end, and so a different value of function GetRNG (see below) output at the end. (PRNG refers to pseudo-random number generator.) The pseudo random number generation process itself in either case is conventional and can be of any type.

In one embodiment, consider each domino piece as being modeled as an integer. Each (notional) piece contains two sides, which can be arbitrarily expressed using macros LEFT_PART and RIGHT_PART. For example, if the domino piece integers are each 32-bits long, LEFT_PART could correspond to the leading 16-bits and RIGHT_PART could correspond to the least-significant (trailing) 16-bits. (The two parts are typically of equal length.)

In the game algorithm, DominoToPick is thus an array (or table) of integers which represent the dominoes packet (deck), from which the (notional) player or user picks a domino piece if he or she has no domino in his or her hand, to place on the (notional) board. On the other hand, DominoToPlay is an array of integers which represents the (notional) dominoes the user has in his possession (hand), i.e. the dominoes that he can (notionally) play.

This embodiment is of one type of domino game, but of course, any type of game rules can be implemented for the present hash function. GameExtremity is a table of two integers, which represents the (notional) line extremities of dominoes: in order to place his dominoes, the notional user can either put a domino corresponding to the left extremity of the line of dominos (GameExtremity[0]) or to the right extremity (GameExtremity[1]). The game algorithm is thus as follows: at each round, the (notional) user looks at the (notional) pieces in his hand to see if one corresponds to the left or right extremities of the board (line of dominoes). This is done in a function called TestlfDominoOK. If this function returns value 0, it means that the domino that is being tested by the function (DominoToPlay[i]) does not correspond to either extremity of the line of dominoes. (In this game algorithm, dominos can only be added to the line of play at its extremities.) Else, the function InsertDomino adds the present domino to the line, i.e. modifies one of the line extremities GameExtremity with the value of the added domino.

IsAPieceOK designates a flag used to insert only one domino piece at each round of play, and also is used to see if even one piece was introduced or not. If no piece was introduced, there are three possible cases: (i) either the player's hand is full (the number of domino in the hand, i.e. NumberOfDominoInHand corresponds to the maximal number of dominos a user can have, i.e. MAXIMAL_NUMBER_OF_DOMINO_IN_HAND), and the (notional) game is over; (ii) or, there are no more dominos to pick in DominoToPick, so the (notional) game is over; (iii) or, the general case, the user picks a domino in DominoToPick and puts it in his hand, i.e. in DominoToPlay. On the contrary, if a domino was placed on the board, it is removed from the hand of the user.

Note that for each of these possibilities, the algorithm is diversified (randomness is increased) in terms of the buffer RngBuffer, with calls to the function InsertPRNG. This is also the case in the function InsertDomino, where, depending on how the domino is inserted, the diversifier value is different.

DIV_START, DIV_GAMEOVER, DIV_PICKPIECE, DIV_GAMEWON are each diversifiers with different assigned values. The value RNG_BUFFER_SIZE designates the size of buffer RngBuffer.

At the end of the game, the hash result (digest) is extracted by selecting conventionally some of the bytes of the buffer RngBuffer. The pseudo-code referred to above is as follows and conventionally is structured like actual (executable) code but less detailed and is in the form of the C computer language:

// At the beginning, initialize the RNG with the input
InitPRNG(RngBuffer, RNG_BUFFER_SIZE, input, inputLength);
// Play the game: first diversify with DIV_START
InsertPRNG(RngBuffer, RNG_BUFFER_SIZE, DIV_START);
// Set the packet of Dominoes with the PRNG
for (i = 0; i < STARTING_NUMBER_OF_DOMINO_TO_PICK; i++)
{

DominoToPick[i] = GetRNG(RngBuffer, RNG_BUFFER_SIZE);

}
NumberOfDominoToPick = STARTING_NUMBER_OF_DOMINO_TO_PICK;
// Fill your hand with some of the dominoes
NumberOfDominoInHand = STARTING_NUMBER_OF_DOMINO_IN_HAND;
for (i=0; i<NumberOfDominoInHand; i++)
{

DominoToPlay[i] = DominoToPick[NumberOfDominoToPick-i-1];

}
NumberOfDominoToPick = NumberOfDominoInHand;
// Extremities
NumberOfDominoToPick−−;
GameExtremity[0] = LEFT_PART(DominoToPick[NumberOfDominoToPick]);
GameExtremity[1] = RIGHT_PART(DominoToPick[NumberOfDominoToPick]);
while (IsCurrentGameFinished == 0)
{

IsAPieceOK = 0;
// Look in the hand if there is one piece to place
for (i = 0; (i < NumberOfDominoInHand) && (IsAPieceOK == 0); i++)
{

PieceChecking = TestIfDominoOK(DominoToPlay[i],

GameExtremity[0], GameExtremity[1]);

if (PieceChecking > 0)
{

InsertDomino(DominoToPlay[i], GameExtremity);
IsAPieceOK = 1;

}
// Remove the piece from the hand; put last one in place of
the removed one
NumberOfDominoInHand--;
DominoToPlay[i] = DominoToPlay[NumberOfDominoInHand];

}
// Test if a piece was placed or not
if (IsAPieceOK == 0)
{

// Test if this is the end of the game
if (NumberOfDominoInHand == MAXIMAL_NUMBER_OF_DOMINO_IN_HAND)
{

// lose the game
IsCurrentGameFinished = 1;
InsertPRNG(RngBuffer, RNG_BUFFER_SIZE, DIV_GAMEOVER);

}
else if (NumberOfDominoToPick == 0)
{

// No more pieces, game is won
IsCurrentGameFinished = 1;
InsertPRNG(RngBuffer, RNG_BUFFER_SIZE, DIV_GAMEWON);

}
else
{

// Pick a new piece
Number Of DominoToPick−−;
DominoToPlay[NumberOfDominoInHand] =
DominoToPick]NumberOfDominoToPick];
NumberOfDominoInHand++;
InsertPRNG(RngBuffer, RNG_BUFFER_SIZE, DIV_PICKPIECE);

}

}

}
return RngBuffer;

Operators used in this pseudo code are conventional for the C computer language. “++” denotes increment by one. “&&” denotes the Boolean logical “And” function. Comments are indicated by “//” and are not compiled.

The domino game algorithm can be repeated several times as defined by a settable security parameter designated kSEC_PARAMETER (not shown in the pseudo code). In this case, the initialization with function InitPRNG is performed only once, but the process of the game is performed kSEC_PARAMETER times.

Note that unlike most known hash functions that operate on blocks treated sequentially (one after the other up to the last block), here one treats the input (message) as it is (but deterministically padded to avoid certain known cryptanalytic attacks). In a variant of the present game algorithm, one could also proceed in the conventional way by sequentially treating the message block after block. In this case, the result of the hash of the first message block (the content of buffer RngBuffer) would be reused to begin the operation on the second block and so, up to the last block of the message.

Finally, in other embodiments the game algorithm can be generalized to play with more than one notional player. In this case, each notional player plays the game in turn. Each player has his own game algorithm. Each has his own set of diversifiers, increasing the randomness by adding complexity. Further, in other embodiments the range of values of each domino piece can vary from one version of the algorithm to another, or according to the loop number depending on the value of constant kSEC_PARAMETER.

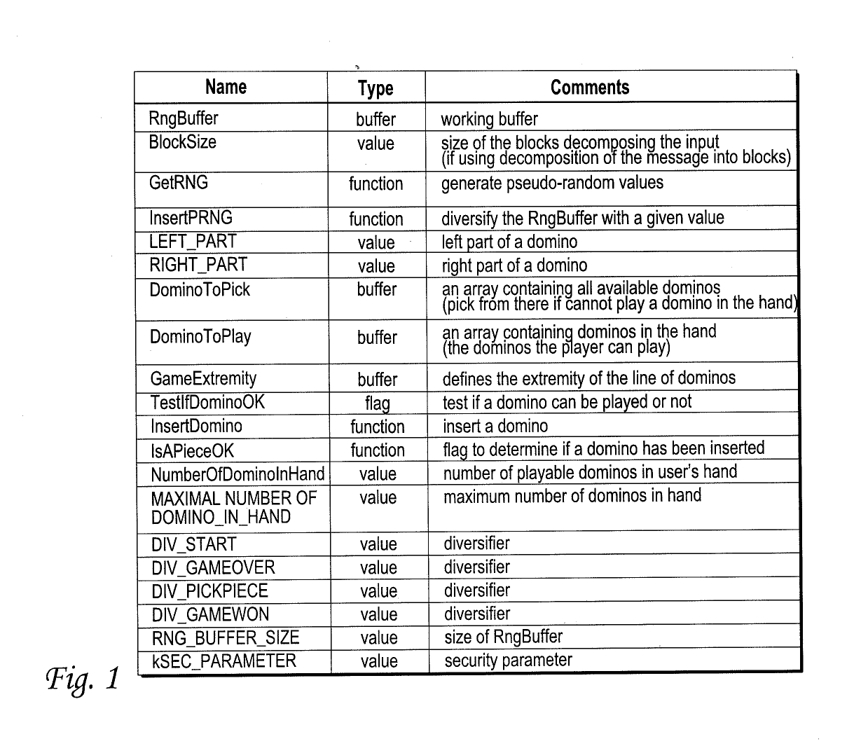

FIG. 1 shows detail of the variables and parameters of the above pseudo code with comments.

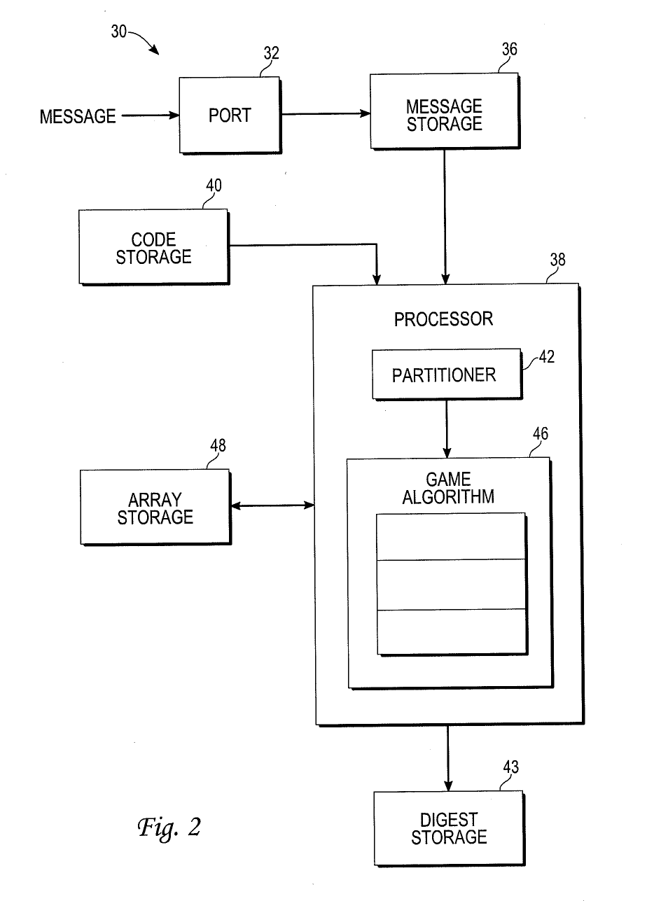

FIG. 2 shows in a block diagram relevant portions of a computing device (system) 30 in accordance with the invention. This is, e.g., a server platform, computer, mobile telephone, Smart Phone, personal digital assistant or similar device, or part of such a device and includes conventional hardware components executing in one embodiment software (computer code) as represented by the above pseudo-code example. This code may be, e.g., in the C or C++ computer language or its functionality may be expressed in the form of firmware or hardware logic; writing such code or designing such logic would be routine in light of the above pseudo code. Of course, the above pseudo code example is not limiting.

The computer code is conventionally stored in code memory (computer readable storage medium) 40 (as object code or source code) associated with conventional processor 38 for execution by processor 38. The incoming message (in digital form) is received at port 32 and stored in computer readable storage medium (memory) 36 where it is coupled to processor 38. Processor 38 conventionally partitions the message into suitable sized blocks at partitioning module 42. Certain of the software (code) modules in storage 40 make up the domino game algorithm module 46 executed by processor 38 and which carries out the pseudo code functionality set forth above. Storage (buffer) 48 stores the array RngBuffer.

Also coupled to processor 38 is a fourth storage 43 for the resulting extracted hash digest. The hash digest is conventionally extracted from the array storage 48, for instance as n consecutive entries so as to provide a hash digest of sufficient fixed length. One can perform this extraction in various ways, so as to extract the needed number of bytes for the digest from the final state of the array 48. Storage locations 36, 43, 48 may be in one or several conventional physical memory devices (such as semiconductor RAM or its variants or a hard disk drive).

Electric signals conventionally are carried between the various elements of FIG. 2. Not shown in FIG. 2 is the subsequent conventional use of the resulting hash digest stored in storage 43, which is compared by processor 38 to a second expected hash digest value associated with the incoming message. Only if the two hash digest values match is the incoming message (a digital document, digital signature or similar information) authenticated.

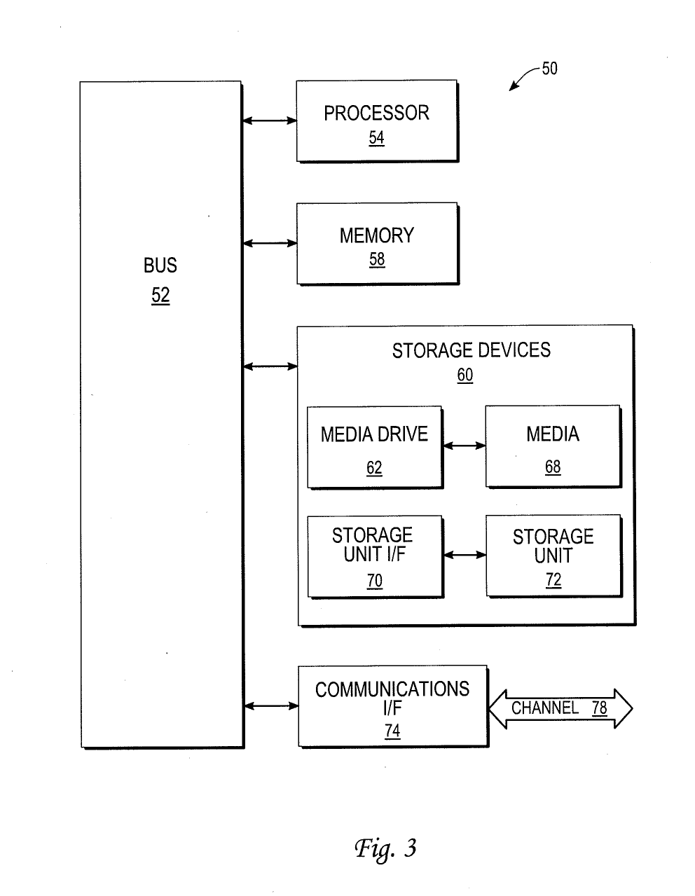

FIG. 3 shows further detail of the FIG. 2 computing device in one embodiment. FIG. 3 illustrates a typical and conventional computing system 60 that may be employed to implement processing functionality in embodiments of the invention and shows additional detail of the FIG. 2 system. Computing systems of this type may be used in a computer server or user (client) computer or other computing device, for example. Those skilled in the relevant art will also recognize how to implement embodiments of the invention using other computer systems or architectures. Computing system 60 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 50 can include one or more processors, such as a processor 64 (equivalent to processor 38 in FIG. 2). Processor 64 can be implemented using a general or special purpose processing engine such as, for example, a microprocessor, microcontroller or other control logic. In this example, processor 64 is connected to a bus 62 or other communications medium. Note that in some embodiments the present process is carried out in whole or in part by “hardware” (dedicated circuitry) which is equivalent to the above described software embodiments.

Computing system 50 can also include a main memory 58 (equivalent to memories 36, 40, 48 in FIG. 2), such as random access memory (RAM) or other dynamic memory, for storing information and instructions to be executed by processor 54. Main memory 58 also may be used for storing temporary variables or other intermediate information during execution of instructions to be executed by processor 54. Computing system 50 may likewise include a read only memory (ROM) or other static storage device coupled to bus 52 for storing static information and instructions for processor 54.

Computing system 50 may also include information storage system 60, which may include, for example, a media drive 62 and a removable storage interface 70. The media drive 62 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 68 may include, for example, a hard disk, floppy disk, magnetic tape, optical disk, CD or DVD, or other fixed or removable medium that is read by and written to by media drive 62. As these examples illustrate, the storage media 68 may include a computer-readable storage medium having stored therein particular computer software or data.

In alternative embodiments, information storage system 60 may include other similar components for allowing computer programs or other instructions or data to be loaded into computing system 50. Such components may include, for example, a removable storage unit 72 and an interface 70, such as a program cartridge and cartridge interface, a removable memory (for example, a flash memory or other removable memory module) and memory slot, and other removable storage units 72 and interfaces 70 that allow software and data to be transferred from the removable storage unit 72 to computing system 50.

Computing system 50 can also include a communications interface 74 (equivalent to port 32 in FIG. 2). Communications interface 74 can be used to allow software and data to be transferred between computing system 50 and external devices. Examples of communications interface 74 can include a modem, a network interface (such as an Ethernet or other network interface card (NIC)), a communications port (such as for example, a USB port), a PCMCIA slot and card, etc. Software and data transferred via communications interface 74 are in the form of signals which can be electronic, electromagnetic, optical or other signals capable of being received by communications interface 74. These signals are provided to communications interface 74 via a channel 78. This channel 78 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 58, storage device 68, or storage unit 72. These and other forms of computer-readable media may store one or more instructions for use by processor 54, to cause the processor to perform specified operations. Such instructions, generally referred to as “computer program code” (which may be grouped in the form of computer programs or other groupings), when executed, enable the computing system 60 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 50 using, for example, removable storage drive 72, drive 62 or communications interface 74. The control logic (in this example, software instructions or computer program code), when executed by the processor 54, causes the processor 54 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A hashing method performed by a computing apparatus and comprising the acts of:
(a) receiving a message at an input port;
(b) storing the received message as an array having a plurality of entries in a first computer readable storage medium coupled to the input port;
(c) a processor coupled to the first computer readable storage and modifying, according to a domino game algorithm stored in a second computer readable medium coupled to the processor, the array;
(d) the processor updating the array stored in the first computer readable storage according to act (c);
(e) using the updated array resulting from act (d) to provide a hash value of the message; and
(f) the processor storing the hash value in a third computer readable storage medium coupled to the processor.

2. The method of claim 1, wherein act (c) includes modeling a set of domino pieces being arranged adjacent one another.

3. The method of claim 2, wherein the modeling includes a plurality of players or games.

4. The method of claim 1, wherein act (b) further includes partitioning the message into a plurality of blocks.

5. The method of claim 2, wherein the modeling includes modeling a line of domino pieces, and modifying the line by adding additional pieces to its extremities.

6. The method of claim 1, further comprising the acts of:
receiving a hash value associated with the message at the processor;
comparing the received hash value to the stored hash value of act (g); and
authenticating the message if the comparison indicates a match.

7. The method of claim 1, wherein the message is one of a digital signature or document, a digital message, a secret key or an identifier.

8. The method of claim 1, further comprising the acts of:
providing a security parameter; and
repeating the method a number of times equal to the security parameter.

9. The method of claim 1, wherein each entry in the array is one bit of data, one byte of data, one 16-bit word, one 32-bit word, one 64-bit word or one 128-bit word.

10. The method of claim 2, wherein the game algorithm includes providing a plurality of diversifier values, each of the diversifier values being associated with a phase of the game algorithm.

11. The method of claim 10, wherein step (f) includes extracting the hash value from the array.

12. The method of claim 5, further comprising:
modeling a plurality of domino pieces as a hand; and
searching the hand for a domino piece that matches one of the extremities.

13. The method of claim 10, further comprising applying one of the diversifier values at a branch condition of the game algorithm.

14. The method of claim 12, wherein if no domino piece matches, adding a domino piece to the hand.

15. The method of claim 14, wherein if the hand is designated as full, applying a diversifier value and completing the game algorithm.

16. The method of claim 14, wherein if the hand is empty, applying a diversifier value and completing the game algorithm.

17. A computer readable medium storing computer code instructions for executing the method of claim 1 on the computing apparatus.

18. An apparatus for computing a hash, comprising:
(a) an input port for receiving a message;
(b) a first computer readable storage medium coupled to the input port for storing the received message as an array having plurality of entries; and
(c) a processor coupled to the first storage medium and which modifies entries for the array according to a domino game algorithm;
(d) wherein the processor updates the array according to (c);
(e) wherein the processor uses the updated array to provide a hash value of the message; and
(f) wherein the processor stores the hash value in a second computer readable storage medium coupled to the processor.

19. The apparatus of claim 18, wherein (c) includes modeling a set of domino pieces being arranged adjacent one another.

20. The apparatus of claim 18, wherein the modeling includes a plurality of players or games.

21. The apparatus of claim 18, wherein (b) further includes partitioning the message into a plurality of blocks.

22. The apparatus of claim 18, wherein the modeling includes modeling a line of domino pieces, and modifying the line by adding additional pieces to its extremities.

23. The apparatus of claim 18, further comprising:
receiving at the processor from the port a hash value associated with the message;
comparing at the processor the received hash value to the stored hash value of (g); and
authenticating the message if the comparison indicates a match.

24. The apparatus of claim 18, wherein the message is one of a digital signature or document, a digital message, a secret key or an identifier.

25. The apparatus of claim 18, further comprising:
providing a security parameter; and
repeating the method a number of times equal to the security parameter.

26. The apparatus of claim 18, wherein each entry in the array is one bit of data, one byte of data, one 16-bit word, one 32-bit word, one 64-bit word or one 128-bit word.

27. The apparatus of claim 18, wherein the domino game algorithm includes providing a plurality of diversifier values, each of the diversifier values being associated with a phase of the domino game algorithm.

28. The apparatus of claim 18, wherein (e) includes extracting the hash value from the array.

29. The apparatus of claim 22, wherein the modeling further includes:
modeling a plurality of domino pieces as a hand; and
searching the hand for a domino piece that matches one of the extremities.

30. The apparatus of claim 27, the modeling further including applying one of the diversifier values at a branch condition of the game algorithm.

31. The apparatus of claim 29, wherein if no domino piece matches, adding a domino piece to the hand.

32. The apparatus of claim 31, wherein if the hand is designated as full, applying a diversifier value and completing the game algorithm.

33. The apparatus of claim 31, wherein if the hand is empty, applying a diversifier value and completing the game algorithm.
